(19) United States
(12) Patent Application Publication
(10) Pub. No.: US 2009/0085765 A1
(43) Pub. Date: Apr. 2, 2009

(54) ARRANGEMENT AND METHOD FOR PROVIDING AT LEAST ONE OPERATING FUNCTION OF A REMOTE CONTROL FOR OPERATING A DEVICE

(75) Inventor: Alfred Bruhn, Karlsruhe (DE)

Correspondence Address: MCCORMICK, PAULDING & HUBER LLP, CITY PLACE II, 185 ASYLUM STREET, HARTFORD, CT, 06103, US

(73) Assignee: MAQUET GmbH & Co. KG, Rastatt (DE)

(21) Appl. No.: 12/200,952

(22) Filed: Aug. 29, 2008

(30) Foreign Application Priority Data
Sep. 1, 2007 (DE) 10 2007 041 687.5
Dec. 18, 2007 (DE) 10 2007 060 808.1

(51) Int. Cl. G08C 19/16; G06F 3/00

(52) U.S. Cl. 340/825.69; 715/700

(57) ABSTRACT

The invention relates to an arrangement and a method for providing at least one operating function of a remote control for operating a device (14 to 20), in which the device (14 to 20) has a storage area in which data containing information relating to this operating function are stored. Provision is also made of a data link between the device (14 to 20) and the remote control (22), which link can be used to transmit data containing the information relating to this operating function from the device (14 to 20) to the remote control (22), the remote control (22) having a data processing unit which processes the information transmitted from the device (14 to 20) to the remote control (22) and, on the basis of this information, provides at least one operating function using at least one operating element (24, 26) of the remote control (22) and/or assigns this operating function to an operating element (24, 26) of the remote control (22).

### CROSS REFERENCE TO RELATED APPLICATIONS

Applicant hereby claims foreign priority benefits under U.S.C. §119 from German Patent Application No. 10 2007 041 687.5 filed on Sep. 1, 2007 and German Patent Application No. 10 2007 060 808.1 filed Dec. 18, 2007, the contents of which are incorporated by reference herein.

### TECHNICAL FIELD

The invention relates to an arrangement and a method for providing at least one operating function of a remote control for operating a device, in which this operating function can be activated using an operating element of the remote control.

### BACKGROUND ART

There are a multiplicity of known technical devices which can be additionally or solely operated using a remote control. They are, in particular, air-conditioning systems, television sets, video recorders, stereo systems etc. There are also a multiplicity of medical devices which can be operated using remote controls. Operating tables with and without additional components, which can be actuated using a remote control, are known, in particular. Such a remote control makes it possible, in particular, to operate the device from a position which is remote from the device to be operated. In particular, the position of elements of an operating table can be changed without the operator, who prompts this, having to avert his gaze from the patient or from a relevant operative site on the patient.

A multiplicity of other devices and apparatuses which can be remotely controlled are known in the medical field. A multiplicity of convenient operating functions of known devices which can be remotely controlled can be activated and performed using remote controls. However, the problem of providing a special remote control for each device arises in practice. So-called learnable remote controls whose coding can be matched to the devices to be operated are also known, in particular, for devices in consumer electronics. Such known learnable remote controls can also be used to operate a plurality of different devices. However, the configuration or programming of these remote controls for a plurality of devices is then very complicated and often requires special knowledge and/or special configuration devices.

Remote controls also make it easier for people with restricted motor skills to use devices. Furthermore, remote controls afford an advantage when it is advisable to operate a device only from a safe distance. This may be expedient, in particular, in the laboratory area in order to maintain a distance from the samples to be investigated using the remotely controlled device and thus to limit risk. Even in the case of other devices, it is possible to reduce the danger to an operator by remotely controlling the device, in particular by means of a wireless remote control. In particular, it may also be expedient to remotely control a device for hygienic reasons.

If an operator would like to operate a plurality of devices which are within a distance which can be reached by a wireless remote control, the problem arises that a separate remote control is then often respectively needed to operate a device and, in order to operate a specific device, the operator must choose and actuate the remote control for this device.

### BRIEF SUMMARY OF THE INVENTION

Only in the case of a plurality of devices from the same manufacturers, for example in the case of components of a HiFi system, are remote controls provided for operating all of the devices of this one specific HiFi system.

The object of the invention is to specify an arrangement and a method for providing at least one operating function of a remote control for operating a device, which can be used to operate a multiplicity of different devices in a simple manner and for which no configuration or only a small amount of configuration is required.

According to a first aspect of the invention, this object is achieved by means of an arrangement for providing at least one operating function of a wireless remote control for operating a device having the features of Patent Claim 1. Further aspects of the invention are specified in the further independent patent claims. Advantageous developments of the invention are specified in the dependent patent claims.

In a first arrangement according to the invention and a first method according to the invention, data containing information are transmitted from the device to the remote control using a data link, with the aid of which at least one operating function is provided using at least one operating element of the remote control and/or with the aid of which this operating function is assigned to an operating element of the remote control. This makes it possible to configure the remote control in a simple manner. In the sense of the invention, the operating function is considered to be, in particular, the activation of a function of the device which is to be remotely controlled. In this sense of the invention, the information comprises, in particular, details of the operating function, configuration data, program data, programming data and/or document data.

In one development of the invention, the information can be transmitted to the remote control using the data link only when the device is switched on. This makes it possible to easily select the device for which the operating function is intended to be provided. It is also advantageous to use the transmitted information to configure an operating function and/or to configure an operator interface. The type and/or arrangement of symbols which can be represented using the operator interface is/are preferably defined on the basis of the transmitted information. Furthermore, it is advantageous that the data can be transmitted using the data link only in the case of a visual link between the remote control and the device. This ensures that it is not possible to inadvertently transmit the data to the remote control.

In one development of the invention, the device can transmit infrared radiation which is received by the remote control using a receiving unit. The infrared radiation transmitted from the device to the remote control is then preferably used to supply power to the remote control. In this case, at least some of the power needed to operate the remote control can be supplied to the remote control using the infrared radiation.

Furthermore, in one development of the invention, data containing information relating to the operating function can be stored in the firmware of the device to be operated. The operating function can be changed, in particular, by updating the firmware and/or part of the firmware of the device to be remotely controlled. This makes it possible, in particular in the event of a change in the device software, to easily also change and adapt the operating functions which are suitable and/or required for operating the device.

It is also advantageous to transmit the data containing the information relating to the operating function from the device to the remote control before desired operation of the device. The data are preferably transmitted immediately before a planned operating action, and/or an operating action which has already been initiated, for remotely controlling the device using the remote control. In this case, it is also advantageous to transmit the data containing the information relating to the operating function provided by the remote control from the device to the remote control on the basis of the orientation of the remote control and/or on the basis of an operating action of an operator. The data link is preferably a wireless data link, with the result that it is possible to wirelessly remotely control the device using the remote control.

Data are preferably only transmitted to the remote control from that device or devices to which the remote control is oriented. This makes it possible to easily select the devices which can be currently operated using the remote control. As a result of orientation of the remote control to at least one further device, this further device can be alternatively or additionally operated using the remote control by transmitting data containing information relating to at least one operating function of this further device to the remote control. The orientation of the remote control to a device is preferably checked using a visual link between the device and the remote control.

In the event of the remote control being simultaneously oriented to a plurality of devices, each of the devices transmits data containing information relating to at least one operating function of the respective device to the remote control, data containing information relating to at least one operating function of the device respectively being stored in a storage area in each of the devices. An anti-collision method which is known from other areas of technology is preferably used to transmit the data from the devices to the remote control in succession and/or in different channels.

It may also be advantageous if the remote control provides a function for selecting a device to be operated from the at least two available devices. After one of the devices has been selected, the at least one operating function for operating the selected device is then provided using the remote control.

It is also possible for the remote control to produce a suitable graphical user interface using the transmitted information, the data transmitted from the device to the remote control preferably containing data for at least one operator interface which can be represented in a browser program module. This makes it possible to easily produce a graphical user interface using the information stored in the device or data stored in the device and to make it available to an operator in the form of a graphical user interface with operating elements using a display unit of the remote control. In this case, it is advantageous if the display unit of the remote control is in the form of a touch-sensitive display unit which also enables operating inputs by means of touch operation, in particular using a finger or a pin. This makes it possible to operate the device in a convenient and simple manner and in a way which can be adapted to the special features of the device.

The data transmitted from the device to the remote control comprise, in particular, data in a format of a document description language, preferably in HTML format. These data can be used to easily produce a graphical operator interface using a display unit of the remote control. The transmitted information preferably comprises program data and/or data in the format of a document description language.

Alternatively or additionally, the information transmitted from the device to the remote control may contain platform-independent program data, preferably Java program data, which can be used to produce a graphical operator interface using a display unit of the remote control. A data processing unit of the remote control can assign the operating function specified by the information to at least one operating element, in particular a pushbutton, of the remote control.

A further aspect of the invention relates to an arrangement and a method for providing at least one operating function of a remote control for operating a device, in which the remote control has a storage area in which data containing information relating to at least one possible operating function of an operating element of the remote control are stored. A data link between the device and the remote control can be used to transmit at least the data containing the information relating to this operating function from the remote control to the device. The device has a data processing unit which processes the information transmitted from the remote control to the device and, on the basis of this information, assigns an operating function to at least one coded signal which is produced by the remote control by actuating an operating element of the remote control and is transmitted to the device. This makes it possible to operate the device without adapting the signal of the remote control to the device by virtue of the remote control informing the device of at least one available operating function and the data processing unit automatically configuring the device in such a manner that, when coding which is assigned to this operating function is received, the device is controlled in a manner corresponding to the operating function.

In one development of the arrangement of the further aspect of the invention, the information can be transmitted from the remote control to the device using the data link only when the device is switched on.

It may also be advantageous for the data processing unit to use the transmitted information to assign the operating function itself, a configuration of an operating function and/or a control and/or output function to be performed by the device to a coded signal. It is also possible to transmit the data using the data link only in the case of a visual link between the remote control and the device. As a result of this, it is possible to ensure that inadvertent operation of the device is prevented if the person operating the remote control is not in the vicinity of the location at which the operating actions of the device have an effect. Furthermore, the visual link can be used to easily select the device and/or devices to be operated.

The device preferably emits infrared radiation which is received by the remote control using a receiving unit. The infrared radiation transmitted from the device to the remote control is preferably used to supply power to the remote control, at least some of the power needed to operate the remote control being supplied to the remote control using the infrared radiation.

The data containing information relating to the operating function can be stored in the firmware of the remote control. The operating function can then be changed in a simple manner and can, if necessary, be adapted to new devices or changed and/or additional operating functions by updating the firmware and/or part of the firmware. The data containing the information relating to the operating function are transmitted from the remote control to the device before, preferably immediately before, the device is operated using the remote control. In particular, the data can be retransmitted before each operating action and/or before an operating cycle which comprises a plurality of individual operating actions. It is thus ensured that the device initiates a corresponding operating action and/or control function of the device when a coded signal assigned to the operating function is received.

The data containing information relating to the at least one operating function of the device are only transmitted from the remote control to that device to which the remote control is oriented. A visual link between the device and the remote control is preferably used to check whether the remote control is oriented to the device.

In the event of the remote control being simultaneously oriented to a plurality of devices, data containing information relating to at least one operating function of the remote control are transmitted to each of the devices. As a result, all of these devices perform a corresponding operating action when a coded signal assigned to this operating function is received. This is particularly advantageous in the case of identical operating functions which are intended to be respectively performed by the devices. A plurality of devices which can be operated are preferably pre-configured in the remote control, different coded signals then being able to be assigned to different devices for identical operating functions. For this purpose, the remote control can provide a selection function for selecting a device to be operated from at least two available devices and, after one of the two devices has been selected using the selection function, the remote control provides the at least one operating function for operating the selected device.

The data processing unit of the device assigns an operating and/or control function of the device to the coded signal produced by the remote control upon actuation of an operating element. The operating element is preferably a pushbutton or a switch of the remote control.

It is expressly pointed out that the methods which are specified in the independent claims and have features of individual dependent arrangement claims or corresponding method features and/or further features which are specified in the description in connection with one of the arrangements according to the invention or methods according to the invention can also be respectively developed.

Further features and advantages of the invention emerge from the following description which, in conjunction with the accompanying figures, explains the invention in more detail using exemplary embodiments.

### BRIEF DESCRIPTION OF THE DRAWINGS

In the figures:

FIG. 1 shows an arrangement for providing at least one operating function of a wireless remote control for operating a plurality of devices in a first orientation of the remote control, and an activated device;

FIG. 2 shows the arrangement according to FIG. 1 with a total of two activated devices;

FIG. 3 shows the arrangement according to FIGS. 1 and 2 with a total of four activated devices; and

FIG. 4 shows the arrangement according to FIGS. 1 to 3 with a further orientation of the remote control and four activated devices.

### DETAILED DESCRIPTION OF THE INVENTION

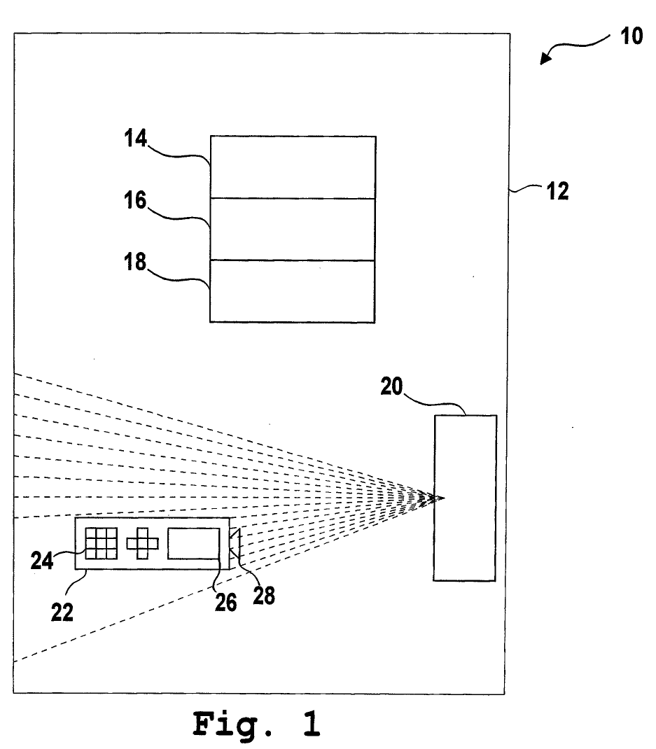

FIG. 1 illustrates an arrangement for providing at least one operating function of a wireless remote control 22 for operating at least one device 14 to 20 which can be remotely controlled. Both the devices 14 to 20 and the remote control 22 are in an enclosed room 12, for example an operating theatre. The devices 14 to 18 are components of an operating table and the device 20 is a further medical device, for example a surgical microscope, an image processing unit and/or display unit of the surgical microscope being able to be remotely controlled using the remote control 22. The devices 14 to 18 may be components of an operating table system which can be operated independently of one another, the device 16 being a basic module of the operating table and the devices 14 and 18 being additional components each having at least one actuator which can be remotely controlled and/or at least one sensor which outputs state information. Such additional components may be, in particular, movable and/or pivotable supports, in particular leg plates or arm plates. Alternatively or additionally, one of the additional components may be a vacuum mattress or another component which is placed on elements of the operating table and is connected to the operating table or is arranged in the area surrounding the operating table.

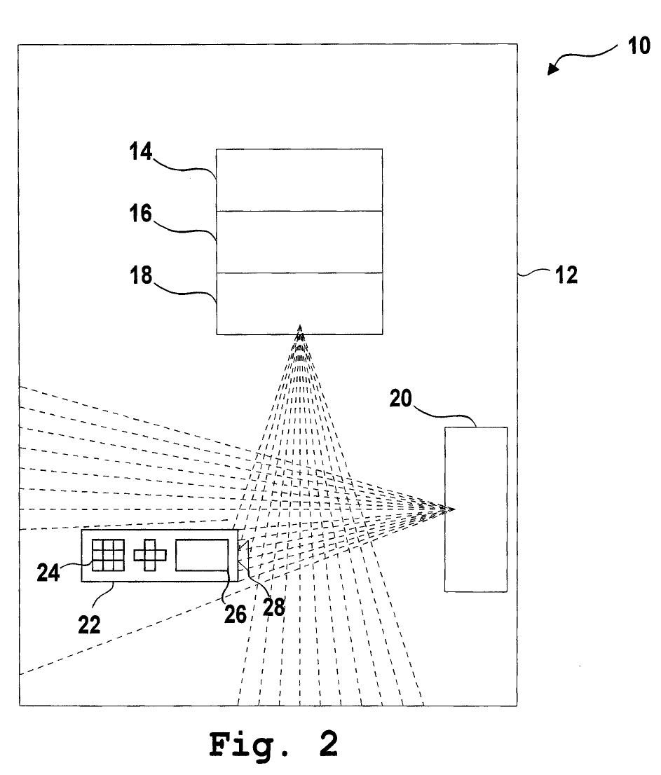

FIG. 1 shows a state of the arrangement 10 in which the remote control 22 is oriented to the device 20 and receives the infrared radiation which is emitted by the device 20 and is respectively diagrammatically illustrated in FIG. 1 and further FIGS. 2 to 4 using dashed lines. As a result of the reception of the infrared radiation emitted by the device 20, the remote control 22 can determine that the device 20 has a visual link to the remote control 22. Furthermore, the infrared radiation emitted by the device 20 can be used to transmit power to the remote control 22, which power can be used by the remote control 22 to supply power to the remote control 22. At least some of the power needed for the display and/or operating actions of the remote control 22 can be supplied to the remote control 22 using this power. The device 20 can use the infrared radiation to transmit data to the remote control 22, which data contain information which is processed by a data processing unit of the remote control 22 and is used by the remote control 22 to produce and configure at least one operating function for operating the device 20 and/or to assign a specific function and/or special coding to an operating element.

In FIG. 1, an operating element of the remote control 22 is provided with the reference symbol 24. This operating element 24 and further operating elements of the remote control 22 are in the form of pushbuttons.

Alternatively or additionally, individual operating elements may also be in the form of switches, preferably in the form of sliding switches. The remote control 22 also comprises a display unit 26 which is in the form of a touch-sensitive display unit 26. This display unit 26 can be used to display further operating elements, individual operating elements being able to be activated, via the touch-sensitive surface of the display unit 26, using the finger of an operator and/or a pin. Further suitable operating elements, such as sliding switches and rotary regulators, can be displayed and operated using this display unit 26. Furthermore, display values can be output in a simple manner. These display values may relate to current measured values and/or setting values of the device 20, in particular.

The remote control 22 also has an infrared receiving and transmitting unit 28. Alternatively or additionally, the remote control 22 also has a further receiving and/or transmitting unit which is based on radio waves and can be used to transmit further data between the device 20 and the remote control 22, in particular an ultrasound receiving and/or transmitting unit. After the infrared rays emitted by the device 20 have been received by the remote control 22, the remote control 22 is activated. The device 20 uses the infrared radiation to preferably transmit an identifier to the remote control 22, which identifier can be used by the remote control 22 to identify and make contact with the device 20. After the remote control 22 has been activated and after the identification information has been received, the remote control 22 initiates the transmission of data from the device 20 to the remote control 22, said data being intended to contain information relating to at least one operating function of the remote control 22 which can be configured. The device 20 then transmits the requested data to the remote control 22.

A data processing unit of the remote control 22 processes these received data and accordingly configures the available operating elements of the remote control 22 or at least some of the available operating elements of the remote control 22. The device 20 can then be operated using the remote control 22. Further configuration of the remote control 22 in order to operate the device 20 is not required. In particular, there is no longer any need to pre-configure the remote control 22 using device data of the device 20 in order to operate the device 20. This procedure makes it possible to both configure a new remote control 22 for existing devices 14 to 20 and to operate a further new device in addition to the devices 14 to 20 without further user intervention for the purpose of configuring the remote control 22.

FIG. 2 illustrates the arrangement 10 according to FIG. 1, in which, in addition to the device 20, the device 18 is also activated and emits infrared radiation. However, the remote control 22 is oriented only to the device 20, with the result that there is only a visual link between the remote control 22 and the device 20 and not between the device 18, which is likewise activated, and the remote control 22. As a result, even when configuring the arrangement 10 according to FIG. 2, it is only currently possible to operate the device 20 and not the device 18 since, in the present exemplary embodiment, operation of the devices 14 to 18 is intended to be prevented without a direct visual link between the remote control 22 and the device 18. The configuration of the remote control 22 using the data transmitted from the device 20 and the processing of the information transmitted using these data are carried out in the same manner as described in connection with FIG. 1.

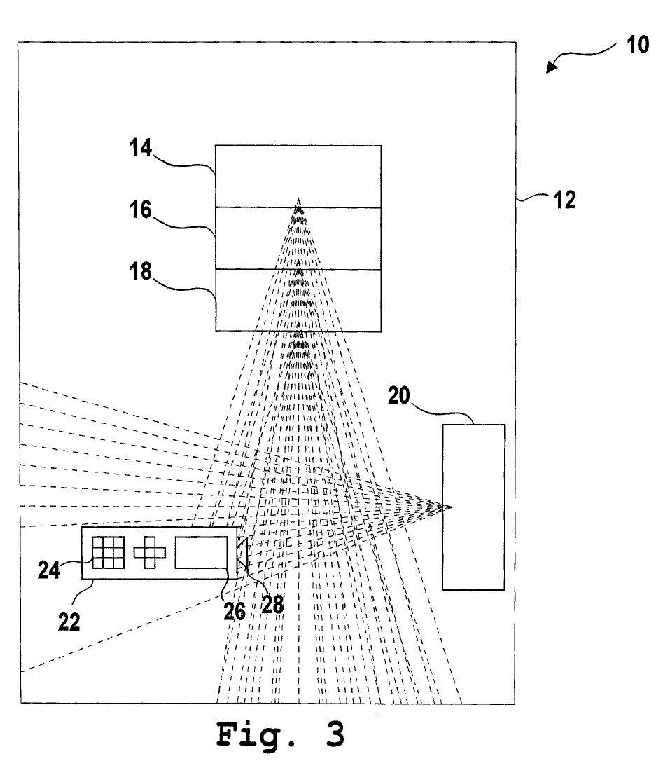

FIG. 3 shows the arrangement 10 according to FIGS. 1 and 2 in a further operating situation in which the devices 14 to 20 are activated and each emit infrared radiation. In this case, each of the devices 14 to 20 preferably transmits a device identifier using the emitted infrared radiation, with the result that the remote control 22 can determine the device identifier from the devices 14 to 18, to which there is a visual link, and can use this device identifier for communication, in particular for initiating the transmission of data containing information relating to at least one operating function which can be configured and is to be provided by the remote control 22. These identifiers can be used to apply an anti-collision method using the remote control 22, which method enables sequential data transmission from those devices 14 to 20 to which there is a visual link.

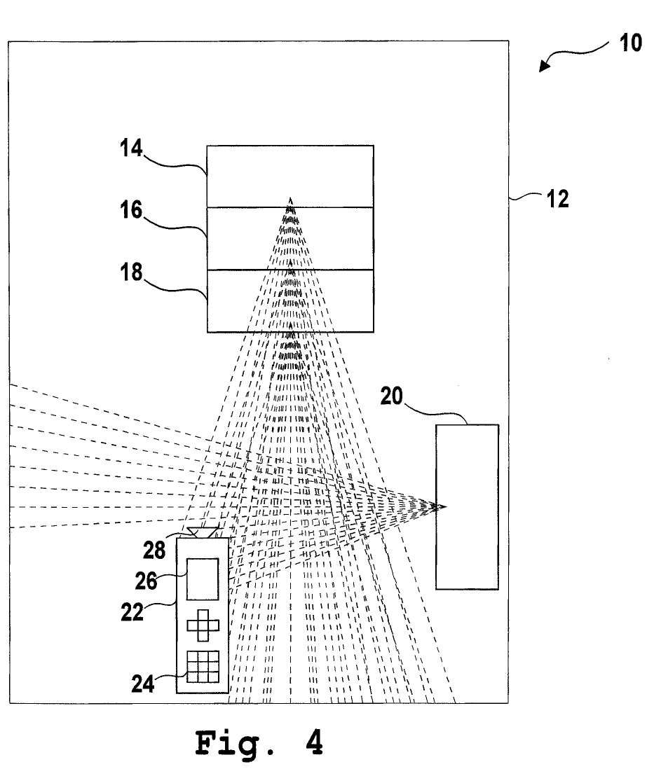

FIG. 4 illustrates the arrangement 10 according to FIGS. 1 to 3, in which the remote control 22 is oriented, in the operating situation illustrated in FIG. 4, in such a manner that it respectively receives the infrared radiation emitted by the devices 14 to 18, with the result that the devices 14 to 18 each transmit power to the remote control 22, which power is used to transmit at least some of the power needed to operate the remote control to the remote control 22. This also makes it possible to ensure that the remote control 22 has a visual link to the devices 14 to 18. The visual link makes it possible to ensure, in particular, that an operator does not unintentionally operate the devices 14 to 18 using the remote control 22, in particular when the operator is outside the operating theatre 12 and cannot have any visual contact with the devices 14 to 18. However, in the operating situation of the arrangement 10 which is illustrated in FIG. 4, the remote control 22 has visual contact with the devices 14 to 18 but not with the device 20. Each of the devices 14 to 18 uses the infrared radiation emitted by the respective device 14 to 18 to transmit an individual identifier, preferably a serial number, a MAC address or another ID, of the respective device 14 to 18, with the result that the remote control 22 can use this identifier to specifically transmit data to the respective device 14 to 18. In particular, this identifier is inserted into the data to be transmitted, for example into a so-called header, and/or the data are encrypted using this identifier and/or on the basis of this identifier.

On the basis of the identifiers transmitted from the devices 14 to 18 to the remote control 22, the remote control 22 initiates the transmission of data containing the required information relating to at least one respective operating function of each of the devices 14 to 18, the remote control 22 respectively initiating the transmission of data from the devices 14 to 18 in succession, with the result that, for example, the data are first of all transmitted from the device 14 to the remote control 22, the data are then transmitted from the device 16 to the remote control 22 and then the data are transmitted from the device 18 to the remote control 22. The orientation of the remote control 22 makes it possible to easily select the device or devices 14 to 20 to be operated, only the operating functions, which are provided for operating the devices 14 to 20, of only those devices 14 to 20 to which the remote control 22 is oriented and to which there is a visual link being configured. In the present exemplary embodiment, selection possibilities for operating further devices, such as the device 20 in FIG. 4, are not offered to the operator using the remote control 22 with the orientation of the remote control 22 shown in FIG. 4.

In the invention, a single remote control 22 is generally used to operate one or more devices 14 to 20 which can be remotely controlled, said remote control having a programmable, variable user interface and/or programmable functions which are kept variable, the operating functions to be provided for operation by means of the remote control 22 and/or operating elements to be provided being produced and/or configured using the information transmitted from the device to be operated to the remote control 22.

A remote control 22 according to the invention need not have any implemented remote control functions in order to operate a device 14 to 20 but rather only at least one operating element, for example a pushbutton 24 and/or a touch-sensitive surface of a display unit 26. Such a remote control 22 has at least one communication unit 28 which preferably comprises a transmitter and a receiver. The remote control 22 additionally has a basic functionality having at least the function of a so-called boot loader which makes it possible for the remote control 22 to load programs which can be used by the remote control 22 to provide the operating functions needed to operate the device 14 to 20. Such boot loaders are known, for example, for loading programs in microcontrollers. However, it is also possible to use other program elements which provide at least one operating function for operating the device 14 to 20 using the remote control 22 on the basis of information transmitted from the device 14 to 20 to be operated to the remote control 22 with the aid of data. This information and/or program data, in which the information is then contained, can also be used to easily configure the arrangement of operating elements 24, 26 and the assignment of operating functions to individual operating elements 24, 26 and to allocate desired operating functions, in particular also operating sequences which are carried out in succession upon actuation of an operating element 24, 26, to the individual operating elements 24, 26 of the remote control 22. The signal coding to be transmitted from the remote control 22 to the device for individual operating functions can also be defined using the received information.

An initialization phase, in which data containing the information needed to provide and/or configure the operating function of the remote control 22 are transmitted to the remote control 22 in order to operate the device 14 to 20 and are processed by a data processing unit of the remote control 22, is preferably provided for this purpose. This makes it possible to easily carry over new function definitions of individual operating functions, which are stored in the device 14 to 20 to be operated, to the remote control 22 and to integrate them in an operating scheme or to implement a new operating scheme.

Therefore, the operating concept of the remote control 22 need not already be defined in detail when manufacturing the remote control 22 but may be transmitted from the respective device 14 to 20 to be controlled itself to the remote control 22 using the information specified by the data, with the result that the operating concept can be predefined by the device 14 to 20 to be operated. As a result, the devices 14 to 20 which did not yet exist at all or were not yet planned when the remote control 22 was delivered can also be operated using the remote control 22. The information provided by the device 14 to 20 to be operated itself can be specifically used by the remote control 22 to provide those operating functions which are required by the device 14 to 20 to be operated for the purpose of optimum operation using the remote control 22, that is to say for controlling operation of the device 14 to 20 using the remote control 22. In this case, the information from the device 14 to 20 may also comprise details which describe at least some of the properties of the device 14 to 20, the remote control 22 using this information to already provide at least some of the operating functions needed to operate the device 14 to 20 with the aid of suitable operating elements 24, 26. The information may also comprise details of device functions of the device 14 to 20 which is to be remotely controlled, with the aid of which the remote control 22 then selects operating functions from preset operating functions and can provide them for the purpose of operating the device 14 to 20.

It is particularly advantageous if the remote control 22 comprises a display unit 26 which, in particular, is in the form of a TFT display, an LCD or an OLED. Suitable symbols for representing operating elements, for example for representing operating keys with suitable self-explanatory symbols, can be output using this display unit 26 and can be activated and thus actuated using a touch-sensitive surface which is provided, for example, by a touch-sensitive film applied to the surface of the display unit 26. The touch-sensitive surface determines when the surface is touched in the touch regions assigned to the individual operating elements. In this case, the coordinates of a point at which the touch-sensitive surface is touched are accurately recorded and, if the coordinate of touch is in a touch region, the operating function assigned to this touch region is activated. This procedure also makes it possible to easily actuate operating elements such as sliding switches or rotary regulators. Furthermore, such a display unit 26 makes it possible to output setting values in the form of numbers or scales. For example, the angle of inclination of individual elements of an operating table, the movement position of individual components of the operating table and other information which is helpful for operating the respective device 14 to 20 may be output in the form of text, numerical values or graphical representations. Known display units having touch-sensitive surfaces are used, in particular, in mobile telephones, display units with modern display technologies, such as OLEDs, having a very low power requirement. This also makes it possible to supply power to remote controls 22 having such display units 26 using the radiation emitted by the device 14 to 20 to be operated, preferably using the emitted infrared radiation. Alternatively, the devices 14 to 20 to be operated may also produce electromagnetic fields, the power needed to operate the remote control 22 then being transmitted to the remote control 22 via this electromagnetic field. A variable electromagnetic field is preferably used to induce a voltage in a coil which is arranged in the remote control 22 and is used to supply power to the remote control 22.

It is also advantageous to adapt the outer shape of a display unit 26, which is to be integrated in the remote control 22, to the requirements of the remote control 22. In particular, a plurality of touch-sensitive or else non-touch-sensitive display units may be provided in the remote control 22. For example, a plurality of display units may be respectively arranged beside one another in the form of pushbuttons 24 and/or may be integrated in mechanical pushbuttons 24 and, on the basis of the device 14 to 20 to be operated, may display a suitable symbol for representing an operating function which is possible by virtue of the pushbutton.

The prior art discloses different hardware description languages, for example VHDL, which can be used to define a hardware function of a hardware component, for example the hardware function of silicon chips. Such hardware description languages are used, in particular, to produce so-called application-specific integrated circuits (ASICs) in order to define the hardware function and, on the basis of the latter, the chip layout of such ASICs.

Programmable logic circuits, so-called field programmable gate array (FPGA) circuits, whose logic functions can be easily defined by means of suitable programming are also known. When such FPGA circuits are integrated in the remote control 22, the logic function provided by the FPGA circuit can be programmed, in particular, using the information which is transmitted from the device 14 to 20 to be operated to the remote control 22 and may also comprise program data. The programming of the logic circuit can be easily changed by erasing existing programming and/or replacing it with other programming. Different logic functions may also be programmed in FPGA circuits for different devices 14 to 20, with the result that the at least one FPGA circuit provides suitable operating functions for operating at least two different devices 14 to 20. Such a concept makes it possible to program the remote control 22 in a relatively free and/or reconfigurable manner. It is also possible for basic logic functions to be programmed in basic programming in the programmable logic module (for example in the FPGA) of the remote control 22 and for individual basic functions and/or further operating functions to be configured and/or additionally provided using the information transmitted from the device 14 to 20 to be operated.

A web browser program module which can be used to output at least one operator interface, which is transmitted from a device 14 to 20 to be operated, in the form of a graphical user interface may also be pre-configured, for example, in the remote control 22. In this case, the graphical user interface may be provided, for example, in a document description language such as the hypertext markup language (HTML). The graphical elements of such a graphical user interface, which are to be displayed, are then described by means of suitable text formats, ASCII code usually being used for this purpose. The description of the graphical user interface, which is provided by the document description language, is then transferred to the browser program module for processing, said browser program module then producing the individual graphical elements in accordance with the description and outputting them using the display unit 26. If permitted by the description of the graphical user interface, the browser program module can also adapt individual elements to the display unit 26, in particular to the representation options of the display unit 26, in particular to the size of the display unit 26.

Individual elements to be displayed may also be provided centrally, for example using a network. The description of the operator interface then contains only a reference to these elements. For example, these elements of the remote control 22 may be provided using a wireless network, in particular a WLAN. As a result, the volume of data to be transmitted from the device 14 to 20 to be operated to the remote control 22 can be considerably reduced since the data containing the graphical elements can be transmitted from a source to the remote control 22 using a separate data link. In this case, the reference to the graphics or to a data source containing these graphics may comprise both a unique identifier and a memory address (for example an IP address). Other elements, for example sound elements, animated graphics and film sequences, can likewise be integrated as elements in the user interface.

The browser program module then loads the stated element from the stated source and integrates it in a suitable manner in the user interface to be produced. If the browser program module needs further program elements to represent or output a stated element, the program element(s) required can be loaded from the browser program module itself or can be integrated in the browser program module by an operator.

Furthermore, conventional operating elements, for example standard operating elements, in particular images for representing pushbuttons and conventional symbols for superimposing and identifying these pushbuttons, may be stored in a memory provided in the remote control 22, with the result that the remote control 22 can quickly access these elements. Further elements required for representation and/or output and/or the information transmitted from the device 14 to 20 to be operated may also be buffered in this memory. Individual elements, and/or all elements, to be output by the remote control 22 can also be transmitted from the device 14 to 20 to be operated to the remote control 22.

Data can be interchanged in different ways between the remote control 22 and a device 14 to 20 to be operated. For example, a data link may be set up using contact elements, such as plug connectors or touching contacts, in particular spring contacts, by inserting the remote control 22 into a receiving tray or a contact station or by mounting the remote control 22 in a device unit provided for this purpose. A direct cable link, preferably using plug connectors, between the remote control 22 and the device 14 to 20 to be operated may also be provided, which cable link is used to set up the data link. Wireless data links which may have different carrier signals, such as ultrasound, infrared, radio etc., and different protocols, such as Bluetooth, GSM, UMTS etc., are alternatively or additionally possible. The data to be transmitted from the device 14 to 20 to be operated to the remote control 22 contain information containing details of the device 14 to 20 to be remotely controlled, in particular what sort of device 14 to 20 it is, what this device 14 to 20 can do, what this device 14 to 20 for controlling and operating or activating individual operating and/or control functions expects from coded signals, abstract details of representations and/or configurations of the operating elements of the remote control 22, the code expected for activating individual operating functions and/or the security protocols expected by the device 14 to 20 to be remotely controlled.

The device 14 to 20 can use the transmitted data to completely or partially program the hardware and/or software of the remote control 22 using HTML data, VHDL data or similar concepts for software and hardware implementation in the remote control 22 by virtue of the data required for programming being transmitted from the device 14 to 20 to be remotely controlled to the remote control 22. If the remote control 22 has suitable program elements, such as the boot loader which has already been mentioned and/or a browser program module, suitable operating elements and/or operator interfaces may be provided in such a simple manner. In particular, the data transmitted from the device 14 to 20 to be remotely controlled to the remote control 22 may also contain information relating to arrangements of individual operating elements with respect to one another, in particular their position relative to one another. As a result of this concept, the remote control 22 can be used to remotely control each device 14 to 20 which transmits the necessary configuration information and/or information relating to the required operating elements to the remote control 22.

Alternatively or additionally, it is also possible for the remote control 22 to have pre-configured operating functions, information relating to these operating functions and the coded signals respectively assigned to these operating functions being transmitted to the device 14 to 20 to be remotely controlled upon activation of the operating function using the remote control 22 in order to configure this device 14 to 20 to be remotely controlled in accordance with the operating functions provided by the remote control 22 and/or to provide appropriate operating functions and/or operating algorithms. In particular, the remote control 22 can transmit data containing information, which comprises details of the operating functions which can be performed by the remote control 22, of the control and operating possibilities which can be provided by the remote control 22, of the security protocols and/or communication protocols which are supported by the remote control 22 and/or of the security protocols and/or communication protocols which are expected by the device 14 to 20 to be remotely controlled, to the device 14 to 20 to be remotely controlled. In this case, it is advantageous if a data processing unit of the device 14 to 20 to be remotely controlled processes this information and selects the operating functions suitable for operating the device 14 to 20 and transmits information relating to these selected operating functions to the remote control 22 in order to adapt the remote control 22 or the operating functions provided by the remote control 22 to the requirements of the device 14 to 20 to be remotely controlled. However, a concept in which only the remote control 22 transmits at least some of the stated information to the device 14 to 20 and no information relating to selected operating functions is transmitted from the device 14 to 20 to the remote control 22 is also possible.

Furthermore, if the device 14 to 20 to be remotely controlled has suitable program elements, the device functions to be provided or operating functions of the device 14 to 20 to be remotely controlled, which can be activated by the remote control 22, can be programmed or configured by transmitting, in particular, suitable program data from the remote control 22 to the device 14 to 20 to be remotely controlled. For this purpose, the device 14 to 20 may have, in the same manner, a boot loader program which then loads program data transmitted from the remote control 22 to the device 14 to 20 to be remotely controlled and provides corresponding operating functions of the device 14 to 20 to be remotely controlled, which can be activated by the remote control 22.

Structures in which data elements of different form and with different contents are combined under the name of the structure are known from the syntax and the definitions of different programming languages, a defined storage area for accessing these data elements being kept ready for this structure. These data elements can then be easily accessed using the name of the structure. Furthermore, an extension of this concept is known, in which the programs associated with the processing of the data of the structure are also added to the structure, as a result of which these programs themselves are part of a structure having an associated name. This procedure is also referred to as object-oriented programming in which individual functions and objects can be called using a name assigned to the object or the function and can be incorporated in a program sequence. A programming language for such object-oriented programming is, for example, C++ in which programming of objects and the practice of calling these objects in an overall program sequence is customary. Such objects may also be called several times in the program sequence using different parameters.

Object-oriented structures may also be used, according to the invention, as program elements for providing at least one operating function for remotely controlling one of the devices 14 to 20 using the remote control 22 in order to provide the operating function itself or to configure the operating function. In this case, it is advantageous that at least one such object is present in the remote control 22, this object being called in a program sequence using parameters which are defined on the basis of the information transmitted from the device 14 to 20 to the remote control 22. As a result, the object is called and processed using parameters which are suitable for operating the device 14 to 20 to be remotely controlled. Alternatively or additionally, an object may be provided in the device 14 to 20 to be remotely controlled itself, parameters for calling the object in a program sequence of the device 14 to 20 to be remotely controlled being defined using the information transmitted from the remote control 22 to the device 14 to 20.

Alternatively, changes in the source code of the respective object may also be made using the transmitted information, the remote control 22 or the device 14 to 20 then recompiling the source code of the object and producing an executable program element. For most object-oriented programming languages, there are compilers for different platforms, with the result that platform independence and processor independence of the remote control 22 or of the device 14 to 20 to be remotely controlled can be achieved by providing the objects in the form of source code. In one development, both data containing information relating to the configuration of individual operating functions and program elements themselves may be transmitted from the device 14 to 20 to be remotely controlled to the remote control 22 and/or from the remote control 22 to the device 14 to 20 to be remotely controlled. The remote control 22 and the device(s) 14 to 20 to be remotely controlled are also referred to as partner devices. The respective partner device is thus preferably informed of the properties and control possibilities of the respective other partner device 14 to 22, as a result of which the partner devices 14 to 22 can adapt their functions in such a manner that it is possible to operate the device 14 to 20 to be remotely controlled using the remote control 22. The remote control 22 or the device 14 to 20 to be remotely controlled may preferably transmit information, which is required for the partner device in order to provide operating functions and to activate these operating functions, in the form of objects to the respective partner device 14 to 22 or in the form of parameters, objects being called using the parameter. Data containing this information or such objects are then preferably interchanged between the remote control 22 and the device 14 to 20 to be remotely controlled immediately after contact has been made.

In the exemplary embodiment according to FIGS. 1 to 4, this interchange would preferably be carried out after setting up a visual link. In other exemplary embodiments, this information or these objects can already be interchanged when data can be transmitted between a potential device 14 to 20 to be remotely controlled and the remote control 22, preferably also when there is no direct visual link between the remote control 22 and the device 14 to 20. If a check is nevertheless carried out in this procedure in order to determine whether there is a direct visual link between the remote control 22 and a device 14 to 20 to be remotely controlled, operating functions can be displayed, on the basis of the visual link, only by that device 14 to 20 to which there is a visual link. However, operating functions may already be pre-configured for all activated devices 14 to 20 which are present in a data transmission range of the remote control 22, which operating functions are then enabled in the case of visual contact between the remote control 22 and the respective device 14 to 20 to be remotely controlled or are made available to the remote control using operating elements 24, 26 of the remote control 22.

Alternatively or additionally, one of the devices 14 to 20, which are positioned in the communication range of the remote control 22, can be selected by an operator using the remote control 22, operating functions then being activated and/or configured only for this device, or for these devices 14 to 20 when a plurality of devices are selected, and being provided using operating elements 24, 26 of the remote control 22.

The information mentioned can also be repeatedly interchanged between the device 14 to 20 to be remotely controlled and the remote control 22 or between the remote control 22 and the device 14 to 20 to be remotely controlled after the device 14 to 20 and/or the remote control 22 has/have been restarted or for the purpose of checking and/or diagnosing the operating function.

Program elements which must be present in the remote control 22 in order to operate a variety of devices 14 to 20 are preferably standardized, the information to be transmitted from the device 14 to 20 to be remotely controlled to the remote control 22 preferably also being standardized. Alternatively or additionally, the program elements required for the device 14 to 20 to be remotely controlled are also standardized, the information, program elements and/or coding to be transmitted from the remote control 22 to the device 14 to 20 to be remotely controlled preferably also being standardized. Standardizing such program elements and preferably standardizing a multiplicity of possible operating elements 24, 26 and/or operating functions makes it possible to considerably reduce the volume of data to be transmitted in order to provide the operating function and to activate operating functions of the device 14 to 20 to be remotely controlled.

Furthermore, this also makes it possible to provide different design schemes which can be defined for an operator or for a remote control 22, different schemes respectively being able to provide a different representation of the operating element for the purpose of activating the same operating function. As a result, the operating function itself is defined by the partner devices 14 to 22 but a displayed operating element and/or the arrangement of the operating element can be defined individually for each remote control 22 or individually for each user of the remote control 22 on the basis of the selected and/or configured scheme.

However, if such operating functions are not standardized or if activation of special operating functions is not provided in the standard, further functions can be provided by the partner device 14 to 22 by providing suitable program elements. A data communication possibility for interchanging the information needed to configure and/or activate individual operating functions is therefore required between the remote control 22 and the device 14 to 20 to be remotely controlled. In particular, the transmission of data must be respectively supported both physically and by the transmission protocol of the partner devices 14 to 22.

In this case, as already mentioned, data can be transmitted with or without the use of wires. The constellation described below is considered to be advantageous for wireless communication between the device 14 to 20 to be remotely controlled and the remote control 22. Two combination channels are provided and activated between the device 14 to 20 to be remotely controlled and the remote control 22, the device 14 to 20 to be operated preferably using a first frequency to transmit data and the waves transmitted by the device 14 to 20 at the first frequency also being able to be used to transmit power from the device 14 to 20 to the remote control 22. In order to provide the visual link, the device 14 to 20 to be remotely controlled may have at least one infrared transmitter and the remote control 22 may have at least one infrared receiver. For bidirectional data transmission, the remote control 22 may additionally have an infrared transmitter and the device 14 to 20 to be remotely controlled may additionally have an infrared receiver.

Different known types of coding, in particular a Manchester code, can be used to code the transmitted data. If at least one of the partner devices 14 to 22 supports a plurality of possible types of coding, the partner devices 14 to 22 can define the coding which is actually used in a first communication. The CAN protocol, for example, can be used as the protocol for data communication. The coded activation data for activating operating functions of the device 14 to 20 to be remotely controlled are preferably transmitted from the remote control 22 to the device 14 to 20 in a wireless manner. Both the remote control 22 and the device 14 to 20 to be remotely controlled can initiate the transmission of data for configuring and/or activating operating functions from the device 14 to 20 to be remotely controlled to the remote control 22 and/or from the remote control 22 to the device 14 to 20 to be remotely controlled.

In a first protocol step, it is possible to define the coding of the carrier signal for further communication. A carrier sense operation, for example, can be carried out for this purpose. For example, the carrier signal is emitted in a defined bit string in the form of a preamble, for example ----1001----1010----0110----0101---- . . . , in unstructured form (-- means that the transmitter is blanked, 0/1 means that the transmitter is on). As a result, the device 14 to 20 to be remotely controlled, in particular, is able to determine the type of bit coding. The preamble defines whether a frequency shift keying method, a frequency modulation method, a phase shift keying method, an amplitude shift keying method or another modulation method is used to modulate the carrier signal for data transmission. After this stipulation, data communication between the partner devices 14 to 22 is easily possible. This data transmission is preferably controlled using a higher protocol level. Alternatively, these configuration steps may be omitted if this stipulation has already been permanently preset by the configuration of the remote control 22 and of the devices 14 to 20 to be remotely controlled.

In one specific exemplary embodiment, the device 14 to 20 to be remotely controlled emits infrared radiation at a frequency F of 250 kHz. The signal is produced in the form of a square-wave signal with a defined phase angle P and is additionally used to transmit power from the device 14 to 20 to the remote control 22. The phase shift keying method is used to code the data to be transmitted, the data being transmitted with Manchester coding and the CAN protocol being used as the data protocol in order to avoid, in particular, a collision when transmitting data between a plurality of devices 14 to 20 to be remotely controlled and the remote control 22. An anti-collision method which is provided in the CAN bus standard is used, in particular, for this purpose. These stipulations make it possible to easily transmit data between the devices 14 to 20 to be remotely controlled and the remote control 22. However, a multiplicity of basic functions of the remote control 22 may already be pre-configured in the remote control 22. These are, for example, on/off functions, in particular for switching the device 14 to 20 on and off, for switching modules and/or functions for starting/stopping individual drives and/or individual functions, for increasing or reducing the volume in the case of acoustic outputs, for increasing or reducing the brightness in the case of display units etc. on and off. These on/off functions may be provided, in particular, by operating elements 24, 26, such as pushbuttons or switches, both the switches and the pushbuttons being able to be provided as operating elements with the aid of a touch-sensitive display unit 26, a so-called touchscreen. These display units 26 make it possible to assign desired shapes to individual operating elements. In particular, a switch or a pushbutton may be represented as a round, rectangular or square element, any desired representations with shading and three-dimensional representations being possible. Both the element for activating the operating function itself and the coding of the signal, which is transmitted from the remote control 22 to the device 14 to 20 to be remotely controlled upon activation of the operating element, are defined by the information which is interchanged between the partner devices 14 to 22.

The specific arrangement of an operating element need not necessarily be defined by the information transmitted from the respective partner device 14 to 22 but rather may be defined in a suitable manner by the remote control 22 itself. The remote control 22 produces or assigns the activation of this operating function to an operating element 24, which is already present, and is configured in this case in such a manner that, upon activation of the operating element 24 by an operating function, a code assigned to this operating element 24 is transmitted from the remote control 22 to the device 14 to 20 to be remotely controlled. Data integrity is preferably ensured by means of suitable security protocols. It is also advantageous if the information transmitted from the device 14 to 20 to be remotely controlled to the remote control 22 only comprises details of the operating function or the operating element suitable for activating the operating function, and the specific representation of the operating element and the arrangement of the operating element are left up to the remote control 22 itself. This may be carried out in a manner similar to that in known browser program modules which can stipulate and/or change at least some specific representations themselves on the basis of the stipulations of the transmitted documents. If the remote control 22 has a display unit 26 for graphically representing graphical user interfaces, the graphical user interface can also be provided using a known browser program module or a special program module which has been adapted for the remote control 22. For example, the specific representation of a pushbutton can be provided by images which are stored in the remote control 22 and have representations of a pushbutton, or by an image of a suitable pushbutton, which is transmitted from the device 14 to 20 to be remotely controlled to the remote control 22, or by an image which is transmitted from another source, for example the Internet or a server, to the remote control 22. The remote control 22 may have hardware switches or hardware pushbuttons 24 for different basic operating functions and/or for emergency operating functions, with the result that “emergency operation” of the device 14 to 20 is possible in the event of failure of the display unit 26. In particular, the remote control 22 may also have an emergency off button which is in the form of a hardware pushbutton 24 in order to deactivate the remotely controlled device 14 to 20 immediately or with a specific emergency off routine in a hazardous situation.

As an alternative to infrared data transmission, ultrasound data transmission between the device 14 to 20 and the remote control 22 is also possible, the ultrasound excitations also making it possible to transmit power from the device 14 to 20 to be remotely controlled to the remote control 22. Alternatively or additionally, the remote control 22 may have switched RFID transponders, the device 14 to 20 to be remotely controlled preferably having a reading unit which transmits at least some of the power needed to operate the RFID transponder to the RFID transponder.

However, if, as already mentioned, infrared radiation is preferably transmitted from the device 14 to 20 to be remotely controlled to the remote control 22, this infrared radiation can be used to optically transmit a modulated carrier signal, which is in an agreed RF frequency range, to the remote control 22. The power of the infrared radiation excites an oscillation at the same frequency as, or at twice or half the frequency of, the frequencies of the carrier signal in a magnetic circuit which is provided in the remote control 22. An electromagnetically superimposed radio-frequency signal which is additionally emitted excites a resonant circuit arrangement in the remote control 22, the frequency of this resonant circuit arrangement being superimposed on the optically excited first frequency. This results in a mixed or envelope curve signal which, following low-pass filtering, comprises the differential frequency of the two radio-frequency signals. The phase angle of the resultant signal results from the difference between the phase angles of the two radio-frequency signals. A superimposition which is formed in the same manner from the signals provided for emission in the device 14 to 20 to be remotely controlled is at the same frequency but has a different phase angle. The superimposition signal transmitted back from the remote control 22 to the device 14 to 20 to be remotely controlled and the reference signal formed in the reading unit of the device 14 to 20 to be remotely controlled have a propagation-time-dictated phase shift with respect to one another, the measurement of which can be used to determine the distance between the reading station of the device 14 to 20 to be remotely controlled and the remote control 22. This makes it possible to determine the distance between the remote control 22 and the device 14 to 20 to be remotely controlled, with the result that it is also possible to easily define an operating radius or operating area around the device 14 to 20 to be remotely controlled, in which the remote control 22 must be situated, so that the device 14 to 20 performs, on the basis of a coded signal emitted by the remote control 22, the control function assigned to this coded signal. With a suitable choice of the transmitting unit which emits infrared light, for example the LED which emits infrared light, it is also possible to ensure that the remote control 22 is situated in a limited angular section with respect to the device 14 to 20 to be remotely controlled in order to transmit data to the device 14 to 20. This makes it possible to produce a directional function which is useful, in particular, when a plurality of different devices 14 to 20 to be remotely controlled need to be controlled using different remote controls 22, these devices are intended to be simultaneously operated using the different remote controls 22, and the remote controls 22 and the devices 14 to 20 to be remotely controlled are at a distance for which it is possible to transmit data to a plurality of devices 14 to 20 at least in theory.

The remote control 22 may also have a so-called initialization key which is used to request the information from the device 14 to 20 to be remotely controlled, which information is then used to configure and/or activate the at least one operating function.

All of the devices 14 to 20 which receive this request preferably transmit their identifier to the remote control 22 in a further step. If the remote control 22 determines at least two identifiers, it provides a user with a selection menu on a standard interface, which menu can be used to select each of the devices 14 to 20 for operation. Alternatively or additionally, individual operating elements for operating the first device 14 to 20 and further operating elements for operating the second device 14 to 20 may also be output at the same time through the remote control 22; preferably in the form of graphical operating elements on a display unit 26 of the remote control 22. When a device 14 to 20 is selected using the selection menu, a representation of an operating element and/or details of the operating function of the respective device function is/are then preferably retrieved in an initialization phase. If the device 14 to 20 to be remotely controlled is already known to the remote control 22, the information transmitted from the device 14 to 20 to the remote control 22 at least in a first initialization phase can be stored in a memory of the remote control 22, with the result that there is not necessarily any need to retransmit data containing this information. This makes it possible, according to the invention, to provide an operating element for activating the operating function of the device 14 to 20 to be remotely controlled.

If another available device 14 to 20 to be remotely controlled is intended to be remotely controlled using the remote control 22, the device 14 to 20 can be selected in a selection menu, in the case of pre-configuration which has already been carried out, and/or the further device 14 to 20 is initialized, corresponding information relating to the operating function or functions of the device 14 to 20 then being transmitted from this further device 14 to 20 to the remote control 22. In this case, the remote control 22 can emit an initialization signal to all devices 14 to 20 within reach which then correspondingly transmit a reply to the remote control 22, with the result that the remote control 22 can determine all devices 14 to 20 to be remotely controlled within reach and can display a selection. In the case of a plurality of devices 14 to 20 which are within reach of the remote control 22 and are to be remotely controlled, these devices 14 to 20 can simultaneously transmit a reply in response to an initialization request from the remote control 22, with the result that the transmission of data to the remote control 22 may be disrupted by the superimposed transmission of data. In order to prevent this, it is possible to use so-called anti-collision methods as are known, for example, from ISO14443-3 or the CAN protocol. If, on the other hand, a plurality of remote controls 22 are simultaneously configured to operate the same device 14 to 20 to be remotely controlled, further restrictions may be provided in order to avoid, in particular, the activation of conflicting operating functions. For example, the device 14 to 20 may permit only one remote control 22, may permit a remote control 22 as a so-called master remote control 22 whose instructions have priority over conflicting instructions from the other remote controls 22, or activation of an operating function may be suspended if conflicting activation operations or opposing operating functions are activated by the different remote controls 22.

It is also possible, in the case of a plurality of remote controls 22, to permit only one of the remote controls 22, namely preferably that remote control which first activates an operating function of the device 14 to 20 to be remotely controlled. If the permitted remote control 22 is then deactivated, in particular since the device 14 to 20 to be remotely controlled has not been operated by the remote control 22 for a preset period of time, a further remote control 22 may be accepted by the device 14 to 20 as the only permitted remote control 22. Alternatively or additionally, one or more remote controls 22 can also be explicitly enabled. For example, additional remote controls 22 can be integrated in an existing communication protocol as newly authorized remote controls or as remote controls which are authorized again.

Should a device 14 to 20 to be remotely controlled be already preset in the remote control 22 in such a manner that the information needed to provide the operating elements for activating operating functions of the device 14 to 20 to be remotely controlled have been transmitted from the device 14 to 20 to the remote control 22 and have been buffered in the remote control 22, the device 14 to 20 itself may initiate retransmission of data containing information relating to the operating functions from the device 14 to 20 to be remotely controlled to the remote control 22 if the device 14 to 20 to be remotely controlled has changed operating functions which require a change to the operating elements of the remote control 22. This may be the case, in particular, when, as a result of preselection switches on the device 14 to 20 to be remotely controlled itself, further functions or other functions of the device 14 to 20 are provided or further or changed operating functions are available following a firmware update of the device 14 to 20.

It is particularly advantageous to provide a wireless remote control 22 for the purpose of operating the device, a wireless data link being provided between the devices 14 to 20 and the remote control 22, which data link can be used to respectively transmit data containing the information relating to at least one operating function from the devices 14 to 20 to the remote control 22.

It is also possible for the remote control 22 to emit a signal containing information whose reception awakens a device 14 to 20 which is in a sleep mode, that is to say switches it back to a normal operating mode. It is also advantageous to store at least some of the information relating to devices 14 to 20 to be remotely controlled in the remote control 22 after data has been interchanged for the first time. This information is then already available to the remote control 22 in the case of repeated operation of the device 14 to 20 and need not be retransmitted from the device 14 to 20 to the remote control 22. This makes it possible to reduce, in particular, the time needed to transmit the data and thus to configure the remote control 22.

After the device 14 to 20 to be remotely controlled and/or the remote control 22 has/have been restarted, the information stored in the remote control 22 and the device 14 to 20 can be collated in order to detect possible changes to the device 14 to 20 and/or to the remote control 22 which are relevant to the operation of the device 14 to 20 and, if necessary, to transmit the information needed for correct operation from the device 14 to 20 to the remote control 22. This may be necessary, in particular following the firmware update (already mentioned) of one of the devices 14 to 20, if operating functions for operating the device 14 to 20 have been changed by or using the firmware update, in particular if new operating functions have been added, existing operating functions have been removed and the control sequence when activating an operating function has been changed.

In the exemplary embodiment shown, the infrared rays are not reflected in the room 12, with the result that the orientation of the remote control 22 to the device 14 to 20 is easily determined by determining whether infrared rays which are emitted by the device 14 to 20 can be received by the remote control 22. In particular, the reception of reflected infrared rays and/or the further processing of the coded information contained in the reflected infrared rays can be prevented. In other embodiments, the remote control 22 captures the infrared rays and the information coded using these infrared rays from each of the devices 14 to 20, irrespective of its specific orientation to the devices 14 to 20, when the remote control 22 and the devices 14 to 20 are situated in one room. In this case, the remote control 22 can also receive, in particular, reflected infrared rays which have been originally emitted by one of the devices 14 to 20. All available devices 14 to 20 are then preferably offered for selection when selecting the devices 14 to 20. If a device, in particular the device 20, is then positioned outside the room 12, with the result that the remote control 22 cannot receive any infrared rays which are emitted by the device 20, only the devices 14 to 18 can be operated using the remote control 22 and not the device 20. Only the devices 14 to 18 are then offered to a user for selection.

While the present invention has been illustrated and described with respect to a particular embodiment thereof, it should be appreciated by those of ordinary skill in the art that various modifications to this invention may be made without departing from the spirit and scope of the present invention.

What is claimed is:

1. An arrangement for providing at least one operating function of a remote control for operating a device,
in which the device has a storage area in which data containing information relating to this operating function are stored,
having a data link between the device and the remote control, which link can be used to transmit data containing the information relating to this operating function from the device to the remote control,
the remote control having a data processing unit which processes the information transmitted from the device to the remote control and, on the basis of this information, provides at least one operating function using at least one operating element of the remote control and/or assigns this operating function to an operating element of the remote control.

2. The arrangement according to claim 1, wherein the information can be transmitted to the remote control using the data link only when the device is switched on.

3. The arrangement according to claim 1, wherein the transmitted information is used to configure an operating function and/or to configure an operator interface, preferably the type and arrangement of symbols which can be represented using the operator interface.

4. The arrangement according to claim 1, wherein the data can be transmitted using the data link only in the case of a visual link between the remote control and the device.

5. The arrangement according to claim 1, wherein device transmits infrared radiation which is received by the remote control using a receiving unit, the infrared radiation transmitted from the device to the remote control being used to supply power to the remote control, at least some of the power needed to operate the remote control being supplied to the remote control using the infrared radiation.

6. The arrangement according to claim 1, wherein data containing information relating to the operating function are stored in the firmware of the device, the operating function being able to be changed by updating the firmware and/or part of the firmware of the device.

7. The arrangement according to claim 1, wherein the data containing the information relating to the operating function are transmitted from the device to the remote control before the device is operated using the remote control.

8. The arrangement according to claim 1, wherein data containing information relating to at least one operating function of a device are transmitted to the remote control only from that device to which the remote control is oriented, a visual link between the device and the remote control preferably being used to check whether the remote control is oriented to the device.

9. The arrangement according to claim 8, wherein, in the event of the remote control being simultaneously oriented to a plurality of devices, each of the devices transmits data containing information relating to at least one operating function of the respective device to the remote control, data containing information relating to at least one operating function of the device being stored in a storage area in each of the devices.

10. The arrangement according to claim 9, wherein the remote control provides a selection function for selecting a device to be operated from the at least two available devices and, after one of the devices has been selected, provides the at least one operating function for operating the selected device.

11. The arrangement according to claim 1, wherein the remote control produces a suitable graphical user interface using the transmitted information, the data transmitted from the device to the remote control preferably containing data for at least one user interface which can be represented on a display unit of the remote control using a browser program module and has operating elements.

12. The arrangement according to claim 1, wherein the data transmitted from the device to the remote control comprise data in a format of a document description language, preferably in HTML format, which can be used to produce a graphical operator interface using a display unit of the remote control.

13. The arrangement according to claim 1, wherein the data transmitted from the device to the remote control contain platform-independent program data, preferably Java program data, which can be used to produce a graphical operator interface using a display unit of the remote control.

14. The arrangement according to claim 1, wherein the data processing unit assigns the operating function to at least one operating element, in particular a pushbutton, of the remote control.

15. A method for producing at least one operating function of a remote control for operating a device,
in which data containing information relating to this operating function are stored in a storage area of the device,
a data link is set up between the device and the remote control, which link is used to transmit data containing the information relating to this operating function from the device to the remote control,
and in which the information transmitted from the device to the remote control is processed using a data processing unit of the remote control and, on the basis of this information, at least one operating function is provided using at least one operating element of the remote control and/or this operating function is allocated to an operating element of the remote control.

16. An arrangement for providing at least one operating function of a remote control for operating a device,
in which the remote control has a storage area in which data containing information relating to at least one possible operating function of an operating element of the remote control are stored,
with a data link between the device and the remote control, which link can be used to transmit data containing the information relating to this operating function from the remote control to the device,
the device having a data processing unit which processes the information transmitted from the remote control to the device and, on the basis of this information, assigns an operating function to at least one coded signal which is produced by the remote control by actuating an operating element of the remote control and is transmitted to the device.

17. The arrangement according to claim 16, wherein the information can be transmitted from the remote control to the device using the data link only when the device is switched on.

18. The arrangement according to claim 16, wherein the data processing unit uses the transmitted information to assign the operating function itself, a configuration of an operating function and/or a control and/or output function to be performed by the device to a coded signal.

19. The arrangement according to claim 16, wherein the data can be transmitted using the data link only in the case of a visual link between the remote control and the device.

20. The arrangement according to claim 16, wherein the device transmits infrared radiation which is received by the remote control using a receiving unit, wherein the infrared radiation transmitted from the device to the remote control is used to supply power to the remote control, at least some of the power needed to operate the remote control being supplied to the remote control using the infrared radiation.

21. The arrangement according to claim 16, wherein data containing information relating to the operating function are stored in the firmware of the remote control, the operating function being able to be changed by updating the firmware and/or part of the firmware.

22. The arrangement according to claim 16, wherein the data containing the information relating to the operating function are transmitted from the remote control to the device before the device is operated using the remote control.

23. The arrangement according to claim 16, wherein data containing information relating to at least one operating function of a device are only transmitted from the remote control to that device to which the remote control is oriented, a visual link between the device and the remote control preferably being used to check whether the remote control is oriented to the device.

24. The arrangement according to claim 23, wherein, in the event of the remote control being simultaneously oriented to a plurality of devices, data containing information relating to at least one operating function of the remote control are transmitted to each of the devices.

25. The arrangement according to claim 16, wherein the remote control provides a selection function for selecting a device to be operated from the at least two available devices and, after one of the devices has been selected, provides the at least one operating function for operating the selected device.

26. The arrangement according to claim 16, wherein the data processing unit of the device assigns the coded signal transmitted from the remote control upon actuation of an operating element to an operating and/or control function of the device, the operating element preferably being a pushbutton of the remote control.

27. A method for providing at least one operating function of a remote control for operating a device,
in which data containing information relating to at least one possible operating function of an operating element of the remote control are stored in a storage area of the remote control,
a data link is set up between the device and the remote control, which link is used to transmit data containing the information relating to this operating function from the remote control to the device,
and in which the information transmitted from the remote control to the device is processed using a data processing unit of the device and, on the basis of this information, an operating function is assigned to at least one coded signal which is produced by the remote control by actuating an operating element of the remote control and is transmitted to the device.
